(19) United States
(12) Patent Application Publication
(10) Pub. No.: US 2009/0269219 A1
(43) Pub. Date: Oct. 29, 2009

(54) Domestic appliance with a sound damper

(75) Inventors: Johannes Langbein, Berlin (DE); Thomas Nawrot, Berlin (DE); Andreas Ziemann, Potsdam (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 11/989,667

(22) PCT Filed: Jun. 28, 2006
(86) PCT No.: PCT/EP2006/063623

§ 371 Date: Jan. 28, 2008

(30) Foreign Application Priority Data
Jul. 29, 2005 (DE) 10 2005 035 651.6
Sep. 27, 2005 (DE) 20 2005 015 241.2

(51) Int. Cl. F16L 55/033

(52) U.S. Cl. 417/312

(57) ABSTRACT

A sound absorber for a flow of gas which is subjected to a noise, including a pipe section which is substantially straight along an axis, is bounded by two openings which are situated one behind the other with respect to the axis and which has a guide body which is fitted into the pipe section approximately on the axis and is held by at least one spoke. A projection of the guide body parallel to the axis on a surface which contains the openings covers this opening substantially completely, and gas can flow around the guide body and an inner surface which faces said guide body substantially without turbulence in the flow.

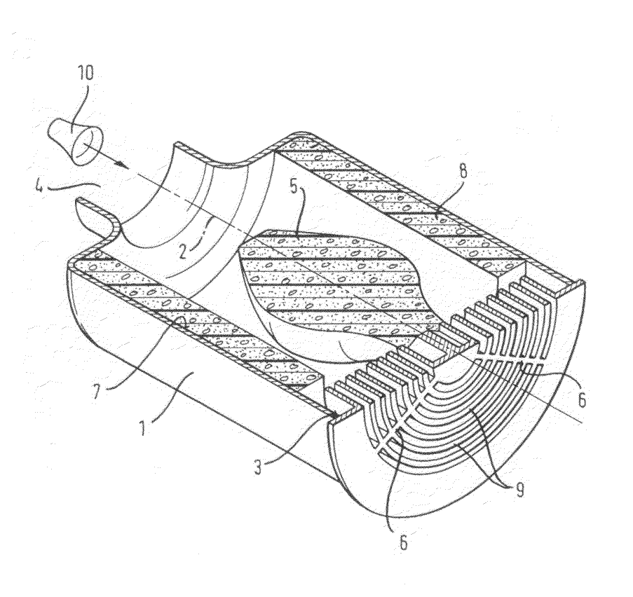

The invention relates to a domestic appliance which incorporates a fan, and a sound damper, for a gasflow which is subject to a noise, where the sound damper incorporates a section of piping which is essentially straight along an axis and which is bounded by two openings (3,4) which lie one behind the other relative to the axis (2).

Such a domestic appliance with a sound damper emerges from each of EP 0 674 747 B1, EP 1 510 166 A2, EP 1 371 920 A2 and EP 1 510 165 A2.

A sound damper of this type is designed to attenuate a noise in a flow of gas, in particular air, and thus to diminish the corresponding disturbance in the surrounding area of an appliance in which the noise is generated. The appliance is, in particular, a domestic appliance such as an air-conditioning unit, a refrigerator, a fume extraction hood or a clothes drier, and the gas is generally air which is sucked into the device from its surrounds for some purpose or other. Each fan used for such a purpose generates a clearly perceptible noise. If an appliance which is provided with such a fan is also to be operated in a quiet environment, for example in a household at night, such a noise can be undesirable.

Accordingly, there is a desire to avoid such noise disturbance, and from this arises a need for a suitable sound damper. A sound damper for a domestic appliance must have the smallest possible dimensions, be as cheap and as simple to manufacture as possible, and must not significantly affect the flow of the gas in which the undesired noise is to be attenuated, and in doing so must above all cause no unwanted loss of pressure.

Accordingly, the invention which is to be described here is based on the object of specifying a sound damper of this generic type which is simple and cheap to manufacture, the use of which avoids any unwanted effects on the gasflow.

To achieve this object, a domestic appliance is specified which incorporates a fan and a sound damper for a gasflow which is subject to a noise, where the sound damper has a section of piping (1) which is essentially straight along an axis (2), which is bounded by two openings (3,4) which, relative to the axis (2), lie one behind the other, the sound damper incorporates a guidepiece, inserted in the section of piping roughly on the axis, which is held by at least one radial support;

where, for this sound damper
a) a projection of the guidepiece parallel to the axis, onto a surface which contains one of the openings, covers this opening virtually completely;
b) the gasflow can flow around the guidepiece and an inner surface facing the guidepiece with essentially no formation of turbulence.

This sound damper has, apart from the conventional characteristics, the advantage that the guidepiece provided smoothes out the gasflow in the section of piping, and hence improves the flow to any fan which is to be connected downstream of the sound damper. Here the other effects on the flow, which can manifest themselves in particular as a drop in pressure over the sound damper, remain exceptionally limited, because the sound damper contains no components of any kind which could contribute to the formation of turbulence and the like, and thus to the further development of noise.

The sound damper will preferably be in a form which has rotational symmetry relative to the axis, in particular circular symmetry.

It is also preferable if the section of piping has a cross-section, in an area around the guidepiece, which is enlarged by comparison with at least one opening. This ensures that any hindrance to the gasflow by a narrowing of the cross-section is excluded.

It is especially preferable that the section of piping has a cladding made of a sound-damping material; alternatively or in addition, the guidepiece will consist of a sound-damping material. Due to the layout of the guidepiece, sound waves to which the gasflow is subject can in no way pass the sound damper without multiple reflections. The use of sound damping materials such as polyurethane foam enhances the damping effect of the sound damper in that the necessary reflection of the sound waves is only possible with a loss of energy. The guidepiece is preferably held by several radial supports, and it is expedient if these are in a rotationally symmetric arrangement. This arrangement contributes to a smoothing of the flow in the sound damper.

It is further preferred if the guidepiece and the inner surface are shaped in such a way that a gasflow can flow through a channel which is formed between them without a flow speed arising in the gasflow which is significantly faster than any flow speed which occurs in the gasflow when it passes through one of the openings. This avoids shock losses and eddies in the gasflow which is flowing through the sound damper. An additional preference is for the openings to include a first and a second opening, where the first opening has a larger cross-section than the second opening, and where the second opening is designed for connection to a source of the noise, in particular a fan.

One particularly preferred embodiment of the sound damper is distinguished by the fact that a first opening has a larger cross-section than a second opening, that the first opening is covered by a grille, and that a source of noise is connected to the second opening. The grille which is provided further smoothes the flow, and thereby supports the damping effect of the sound damper. Connection of the source which produces the noise to the smaller of the two openings in the section of piping provides additional support.

One preferred use of the sound damper is on a fan in a domestic appliance.

An exemplary embodiment of the invention is explained below, by reference to the drawing.

The only FIGURE shows a sound damper for a flow of a gas, which is subject to a noise, which flows through the section of piping 1 along the axis 2, in the opposite direction from the arrow. The section of piping 1 is bounded by two openings 3 and 4 which, relative to the axis 2, lie one behind the other. Provided in the inside of the section of piping 1 is a guidepiece 5, held by a number of radial supports 6. This guidepiece 5 extends outwards at right angles to the axis 2 so far that its projection parallel to the axis 2, onto a surface which contains the second opening 4, essentially completely covers this second opening 4. Consequently, when viewed from the first opening 3 the second opening 4 is completely obscured by the guidepiece 5, and this means that a sound wave emanating from the second opening 4 can only reach the first opening 3 after multiple reflections in the sound damper. Apart from this, the guidepiece 5 and an inner surface 7, of the section of piping 1, which faces it are so arranged that it is possible for the gasflow to flow past them essentially without the formation of any turbulence. This means, in particular, that sharp edges which extend more or less across the flow, and at which turbulence could form, are avoided. The guidepiece 5 is held by several radial supports 6, which are provided in a grille 9 set into the second opening 3 in the sound damper, to which the guidepiece 5 is attached, in particular by adhesive or snap fastenings.

The section of piping 1 has a cladding 8 of a sound-damping material, for example polyurethane foam; the guidepiece 5 also consists of an appropriate material.

The guidepiece 5 and the inner surface 7 are shaped in such a way that the gasflow can flow through a channel which is formed between them without a flow speed arising in the gasflow which is significantly faster than any flow speed which occurs in the gasflow when it passes through one of the openings 3, 4. In the present case, the second opening 4 has a smaller cross-section than the first opening 3, so that the criterion just mentioned is satisfied if the flow speed in the channel remains less than in the second opening 4. This avoids shock losses and eddies in the gasflow which is flowing through the channel.

A source 10 of the noise which is to be damped is sketched in the region surrounding the second opening 4. This source 10 is, in particular, a fan in a domestic appliance. From this source 10, the sound passes in the direction of the arrow through the second opening 4 into the sound damper, where it is damped to such an extent that outside the grille 9, which would be arranged on an outside surface of a domestic appliance, it is no longer perceptible or, at least, with a remaining intensity which is no longer in any way disturbing.

The sound damper is suitable for use in any domestic appliance which has a fan for drawing in air.

1-10. (canceled)

11. A domestic appliance comprising:
a fan; and
a sound damper that includes:
a pipe having a first opening; and
a guide in the section of piping.

12. The domestic appliance of claim 11, wherein the guide is held by a radial support in the pipe.

13. The domestic appliance of claim 12, wherein the radial support includes a plurality of radial supports.

14. The domestic appliance of claim 11, wherein a projection of the guide essentially completely covers the first opening.

15. The domestic appliance of claim 11, wherein a flow of gas through the sound damper is essentially without turbulence.

16. The domestic appliance of claim 11, wherein the sound damper has a circular rotational symmetry relative to an axis.

17. The domestic appliance of claim 11, wherein the pipe has a larger cross-section in an area around the guide than the first opening.

18. The domestic appliance of claim 11, wherein the pipe has a cladding.

19. The domestic appliance of claim 18, wherein the cladding is a sound-damping material.

20. The domestic appliance of claim 11, wherein the guide includes a sound-damping material.

21. The domestic appliance of claim 20, wherein the sound-damping material is a polyurethane foam.

22. The domestic appliance of claim 11, wherein the guide and an inner surface of the pipe define a channel through which gas can flow having a flow speed which is not significantly faster than a flow speed through the first opening.

23. The domestic appliance of claim 11, further comprising a second opening in the pipe having a smaller cross-section than the cross-section of the first opening.

24. The domestic appliance of claim 23, wherein the second opening is connected to the fan.

25. The domestic appliance of claim 23, wherein the first opening is covered by a grille

26. The domestic appliance of claim 25, wherein the guide is attached to the grille by an adhesive or a snap fastener.

27. A domestic appliance comprising:
a pipe with an opening; and
a guide having a projection along an longitudinal axis of the pipe that covers the opening.

28. The domestic appliance of claim 27, wherein the guide and the pipe define a channel for a turbulence free flow of gas.

29. The domestic appliance of claim 27, wherein the guide and the pipe define a channel through which a flow of gas has a flow speed that is not significantly faster then through the opening in the pipe.
